(19) United States
(12) Patent Application Publication
(10) Pub. No.: US 2003/0056635 A1
(43) Pub. Date: Mar. 27, 2003

(54) Mute for stringed instrument

(76) Inventor: Jane F. Hollander, Milwaukee, WI (US)

Correspondence Address: MICHAEL BEST & FRIEDRICH, LLP, 100 E WISCONSIN AVENUE, MILWAUKEE, WI, 53202, US

(21) Appl. No.: 10/167,560

(22) Filed: Jun. 12, 2002

Related U.S. Application Data
(60) Provisional application No. 60/297,691, filed on Jun. 12, 2001.

(51) Int. Cl. G10D 1/10

(52) U.S. Cl. 84/273

(57) ABSTRACT

A mute for a stringed instrument which includes a character or caricature.

### FIELD OF THE INVENTION

The invention relates to a mute for a stringed instrument, and more particularly, to a mute for a stringed instrument including a character such as a person, animal, place or thing and designed specifically for young players.

### BACKGROUND OF THE INVENTION

Mutes of the violin family are used to change the timbre and reduce the loudness of the instrument. Solo repertoire, chamber music and orchestral music all require the muting of stringed instruments from time to time. Mutes are small devices which fit onto the bridge of the stringed instrument and are either permanently affixed or removable.

In recent years there has been an emphasis on early training and development of the young string player, resulting in a significant population of young musicians. Players may begin training as early as three years of age and continue their lessons throughout their elementary and high school years.

Mutes available to string players include several varieties. They can be fashioned of wood, hard leather, plastic, metal, rubber, or a combination of materials. When in playing position they all perform the same function and produce a relatively similar result. Whether they are permanent or removable, and regardless of the materials used, all manifest a utilitarian style.

### SUMMARY OF THE INVENTION

The invention provides a mute for a stringed instrument that is particularly adapted for the young string player. The mute of the present invention performs the functions of a mute when in the playing position, however, the mute is also configured to be a character such as of a person, animal, place or thing intended to delight the young string player. Such a mute is a whimsical device to entice and excite a young player without offending the serious musician. The mute softens the sound of any of the violin family instruments while appealing to younger players who take delight in seeing the friendly face of a mouse or other person, animal, place or thing atop the bridge of their instrument.

Features and advantages of the invention will become apparent to those of ordinary skill in the art upon review of the following detailed description and drawings.

### BRIEF DESCRIPTION OF THE DRAWINGS

FIG. 1 is a front view of a first embodiment of the mute of the present invention including a caricature of a mouse in a tuxedo;

FIG. 2 is a back view of the mute of FIG. 1;

FIG. 3 is a side view of the mute of FIG. 1;

FIG. 4 is a perspective view of another embodiment of the mute in the playing position;

FIG. 5 is a perspective view of another embodiment of the mute in the playing position;

FIG. 6 is a top view of the mute of FIG. 4 in the playing position; and

FIG. 7 is a front view of a third embodiment of the present invention including a caricature of Mozart.

Before one embodiment of the invention is explained in detail, it is to be understood that the invention is not limited in its application to the details of construction and the arrangement of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE PREFERRED EMBODIMENT

Referring to the drawing, various embodiments of the mute of the present invention are shown. The mutes are designed to include a character or caricature and are primarily for the young stringed instrument player. The stringed instruments for which this mute is suited are the violin, the viola, the cello and the bass. The mute is used to reduce the sound of the instrument and is employed such as in orchestral, chamber music, or solo playing.

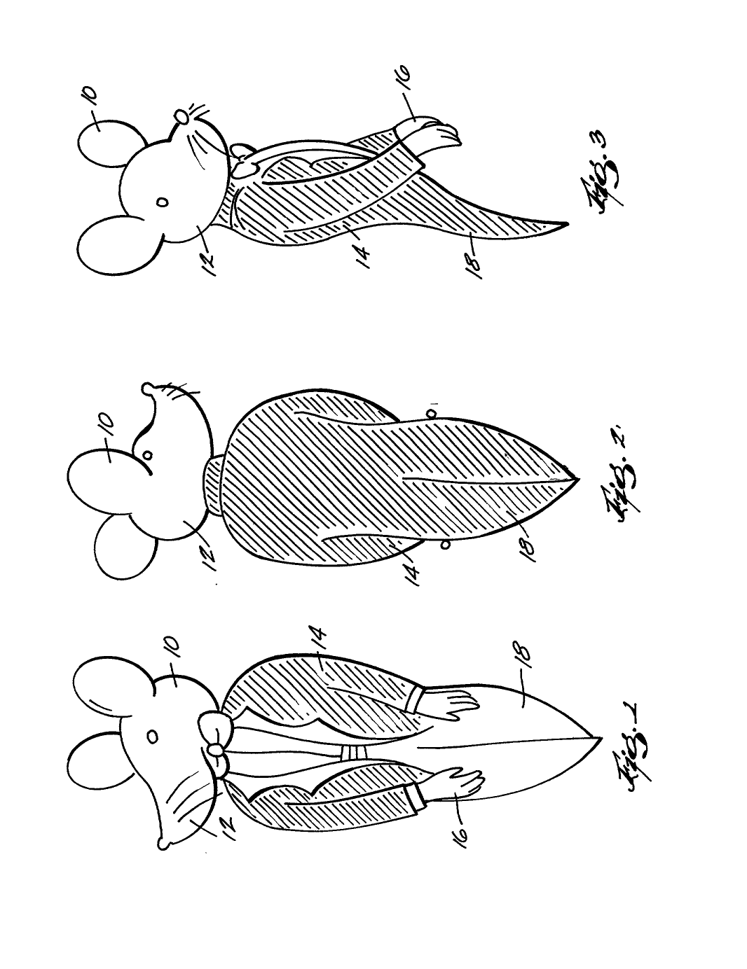

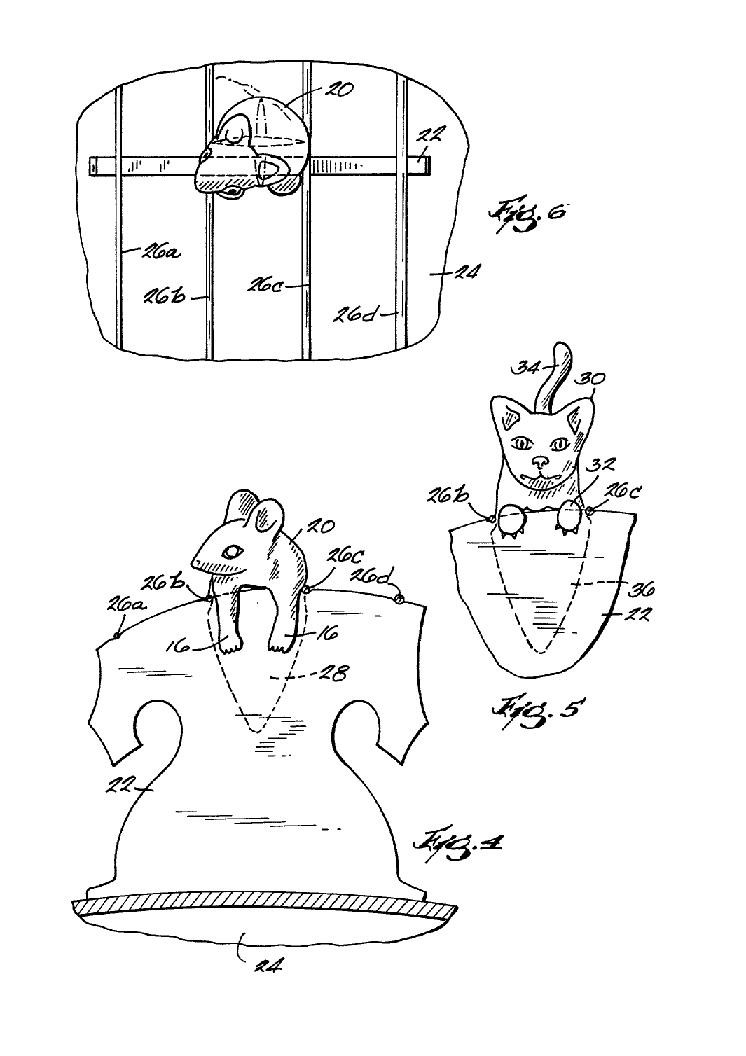

Specifically, the mute 10 of the first embodiment shown in FIGS. 1-3 includes the head 12 and torso 14 of a mouse figure, dressed in concert attire. In use, the mute 10 sits atop the bridge of any of the violin family instruments. Its use allows players to play “quiet as a mouse”. In use, the mouse's front paws 16 extend over the front of the bridge of the stringed instrument while the tails of its tuxedo 18 extend over the rear of the bridge, reducing the bridge's capacity for full vibration thus reducing sound. The stringed instrument's bridge is straddled by the mouse's paws 16 in the front and the tails of the mouse tuxedo 14 in back of the bridge.

The mute 10 of the present invention is affixed to the instrument by placing it sideways between the middle two strings of the instrument, between the bridge and the tailpiece. It is then turned one quarter rotation to allow it to face the player and engage the two middle strings in the slotted openings between the arm and torso on each side of the mouse. When the mute 10 is in a playing position, its front paws straddle the bridge between the two middle strings. The tuxedo tails 14 abut the back of the bridge either straddling the two middle strings or fitting between the two middle strings.

When in its rest position, the mute 10 is lifted slightly to remove the paws from the bridge and the mute 10 is then slid down to the tailpiece where it rests until needed. It is glided back up to the bridge without removal from the strings, for reengagement in its playing position.

FIGS. 4 and 6 shows a second embodiment of a mute 20 in the playing position on bridge 22 on a stringed instrument 24 including strings 26a-d. The character in this second embodiment is also a mouse with paws 16 and a body portion 28. The phantom lines in FIG. 6 illustrate the rotation of the mute 20 into the playing position.

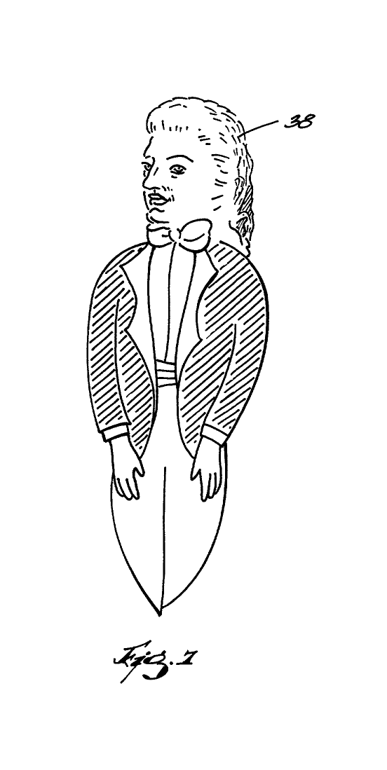

FIG. 5 shows a third embodiment of a mute 30 in the playing position on the bridge 22 of the stringed instrument. The caricature of this mute is that of a cat with paws 32, a tail 34 and a body portion 36.

FIG. 7 shows a fourth embodiment of mute 38 which includes a caricature of Mozart.

The characters and caricatures shown herein include an example of animals (mouse and cat) and a person (Mozart). However, it should be noted that the invention is not limited to these two specific examples. For example, the mute could include other animals or other persons. Further, the character could be of a place or location such as Carnegie Hall or a thing such as a treble clef.

The mute of the present invention is preferably fabricated of hard plastic or rubber, however, other materials can also be utilized.

What is claimed is:

1. A mute for a stringed instrument having a bridge and strings, said mute comprising:
a character; and
a body portion connected to the character and contacting the strings and bridge of the instrument, the body portion being removably fastenable to the bridge.

2. The mute of claim 1 wherein the mute is adapted to sit atop the bridge of the stringed instrument.

3. The mute of claim 1 wherein the character is intended to be whimsical and provide entertainment to a younger player of the stringed instrument.

4. The mute of claim 1 wherein the body portion has a slot and wherein the body portion is removably fastenable to the bridge by placing the body portion over the bridge such that the slot contacts the bridge.

5. The mute of claim 4 wherein the body portion has a slot and wherein at least one string is positionable in the slot.

6. The mute of claim 5 wherein the character and the body portion are the representation of a cat dressed in a tuxedo with paws that are adapted to hang over the bridge, the slot is formed between the paws and the tails of the tuxedo and is substantially parallel to the bridge, wherein the tails of the tuxedo hang over the bridge, and wherein the slot is located between the arms and torso of the cat.

7. The mute of claim 5 wherein the character and the body portion are the representation of a mouse dressed in a tuxedo with paws that are adapted to hang over the bridge, the slot is formed between the paws and the tails of the tuxedo and is substantially parallel to the bridge, wherein the tails of the tuxedo hang over the bridge, and wherein the slot is located between the arms and torso of the mouse.

8. The mute of claim 5 wherein the character and the body portion are the representation of Mozart dressed in a tuxedo with arms that are adapted to hang over the bridge, the slot is formed between the arms and the tails of the tuxedo and is substantially parallel to the bridge, wherein the tails of the tuxedo hang over the bridge, and wherein the slot is located between the arms and torso of Mozart.

9. A mute for a stringed instrument having a bridge and strings, the mute comprising:
a character; and
a body portion integral with the character and contacting the strings and bridge of the instrument wherein the body portion is removably fastened to the bridge, wherein the mute has a play position and a rest position, in the play position the mute is slidable along the strings without complete removal to the rest position, and slidable along the strings from the rest position to the play position without complete removal.

10. The mute of claim 9 where the character is intended to be whimsical and provide delight to a younger player of the stringed instrument.

11. The mute of claim 9 wherein the body portion has a slot and wherein the body portion is removably fastened to the bridge by placing the body portion over the bridge such that the slot contact the bridge.

12. The mute of claim 11 wherein the body portion has a slot and where at least one string is positionable in the slot.

13. The mute of claim 12 wherein the character and the body portion are the representation of a cat dressed in a tuxedo with paws that are adapted to hang over the bridge, the slot is formed between the paws and the tails of the tuxedo and is substantially parallel to the bridge, wherein the tails of the tuxedo hang over the bridge, and wherein the slot is located between the arms and torso of the cat.

14. The mute of claim 12 wherein the character and the body portion are the representation of a mouse dressed in a tuxedo with paws that are adapted to hang over the bridge, the slot is formed between the paws and the tails of the tuxedo and is substantially parallel to the bridge, wherein the tails of the tuxedo hang over the bridge, and wherein the slot is located between the arms and torso of the mouse.

15. The mute of claim 12 wherein the character and the body portion are the representation of Mozart dressed in a tuxedo with arms that are adapted to hang over the bridge, the slot is formed between the arms and the tails of the tuxedo and is substantially parallel to the bridge, wherein the tails of the tuxedo hang over the bridge, and wherein the slot is located between the arms and torso of Mozart.

16. A mute for a stringed instrument in the violin family having a bridge and strings, said mute comprising:
a body adapted to represent the likeness of a mouse wearing a tuxedo, the body including two paws that are positionable over the bridge, tails of the tuxedo positionable over the bridge, and a slot formed between the paws and the tails that is substantially parallel to and contacting the bridge, wherein the body contacts the strings and bridge of the instrument, is removably fastenable to the bridge, and is intended to be whimsical to delight a younger player of the stringed instrument.

17. The mute of claim 16 wherein the body portion has a slot and wherein at least one string is positionable in the slot.

18. The mute of claim 17 wherein the mute has a play position and a rest position, in the play position the mute is slidable along the strings without complete removal to the rest position, and slidable along the strings from the rest position to the play position without complete removal.
